(19) United States
(12) Patent Application Publication
(10) Pub. No.: US 2007/0145682 A1
(43) Pub. Date: Jun. 28, 2007

(54) Reconfigurable game pad

(76) Inventors: Rick Rowe, Las Vegas, NV (US); Jim Rowe, Henderson, NV (US)

Correspondence Address: WEIDE & MILLER, LTD., 7251 W. LAKE MEAD BLVD., SUITE 530, LAS VEGAS, NV, 89128, US

(21) Appl. No.: 11/518,528

(22) Filed: Sep. 8, 2006

Related U.S. Application Data
(60) Provisional application No. 60/715,638, filed on Sep. 9, 2005.

(51) Int. Cl. A63F 13/02; A63F 9/00

(52) U.S. Cl. 273/148 R; 273/148 B

(57) ABSTRACT

A game pad is configured for use on a desk or similar surface. The game pad simulates a casino game table, but is configured for use by a single player, and particularly in conjunction with a computer display. The game pad has a base. A raised rail extends around a portion of a periphery of the base. An opposing portion or end of the base is open. A covering, such as a felt, is located over a central portion of the base. The covering may be interchangeable, permitting the appearance of the game pad to be changed. In one embodiment, the game pad may include illumination devices.

### RELATED APPLICATION DATA

This application claims priority to U.S. Provisional Application Ser. No. 60/715,638, filed Sep. 9, 2005.

### FIELD OF THE INVENTION

The present invention relates generally to consumer oriented gaming equipment, and more particularly to a game pad particularly suited to play of games at a desk or similar surface.

### BACKGROUND OF THE INVENTION

There are many types of game play oriented tables available for the consumer today. Some of these tables may be changed to enable a plurality of game types to be played by the consumer. There are also portable poker tables which provide the consumer with a product that may be easily moved around in their home when game play is desired.

For example, U.S. Pat. No. 4,041,880 to Schankman discloses a convertible poker table. The table is a folding table which may be manufactured using a plastic form and may include fillers which provide for cup holders to be placed on the table itself. Schankman teaches that such a table may be used as a dining table when not in use for poker game play. While Schankman discloses a table which may be used by the consumer for a variety of different purposes, the table has numerous limitations. One such limitation is that the consumer has no ability to change the look of the table. Another limitations of the Schankman design is the polygon shape of the table. While each player may have a side to play from, the maximum number of players is limited to the number of sides of the game table. Yet another limitation is the rather complex construction of the table, which has many parts.

Yet another limitation is that poker tables are currently constructed for a single dedicated use: to be used in self-supporting, stand-alone fashion for multi-player use. These tables thus do not lend themselves to other uses, such as individual online poker players.

### SUMMARY OF THE INVENTION

The invention is a configurable game pad, preferably specifically configured to ornamentally simulate one end section of a poker table and be used as a “desk pad.” In one embodiment, the game pad comprises a base, a cover and a rail.

Preferably, the base is a single piece of molded plastic, and is generally rigid. The base has a pair of opposing sides and a peripheral edge. In a preferred embodiment, the base has a curved peripheral edge which terminates at a generally straight end, such that the game pad is generally half-oval or semi-circular in shape.

A covering or insert is preferably associated with at least one side of the base. The covering may be a felt covering of a variety of patterns. In a preferred embodiment, the covering is detachably connected to the base, thus permitting the user to change the insert or covering which is attached thereto. This permits the configuration of the game pad, including its appearance, to be easily changed.

In a preferred embodiment, the game pad includes a rail which is located at the curved peripheral edge of the base. In one embodiment, the base has a raised peripheral edge and the rail is located at that raised portion of the base, at one side thereof. In this configuration, the straight table end defines a generally open end of the game pad.

In one embodiment, the game pad may include a variety of other features, such as cup or food holders. The game pad may include one or more illumination devices. The game pad may also be stored and transported in a cover or case.

Further objects, features, and advantages of the present invention over the prior art will become apparent from the detailed description of the drawings which follows, when considered with the attached figures.

### DESCRIPTION OF THE DRAWINGS

FIG. 1 is a perspective view of a game pad shown in use on a desk surface and positioned adjacent a display device;

FIG. 2 is an exploded view a game pad constructed in accordance with the present invention along with a carrying case therefore; and

FIG. 3 illustrates a game pad of the invention in a carrying/storage case;

FIG. 4 illustrates, in cross-sectional view, a portion of the game pad illustrated in FIG. 1 in greater detail;

FIG. 5A is perspective view of a game pad with illumination devices in accordance with another embodiment of the invention; and

FIG. 5B is a cross-sectional view of the game pad illustrated in FIG. 5A.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

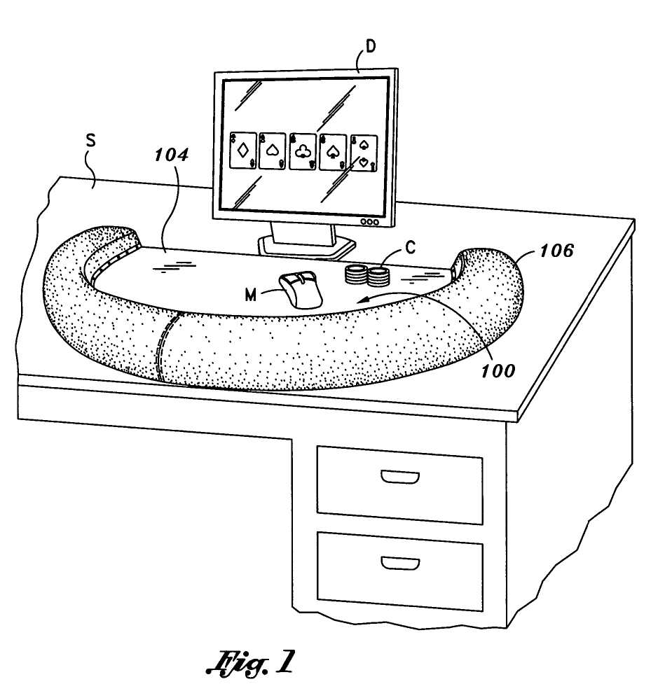

The invention will generally be described with reference to FIG. 1. In general, the invention is a game pad 100 which is particularly suited for use on a desk or similar support surface. For this reason, the game pad 100 may be is referred to as a game desk pad or desk-top game pad. The game pad 100 has particular use in playing card and similar games, such as online poker, and as such may also be referred to as a “poker” pad. It will be appreciated, however, that the game pad may be used for other purposes, including playing games other than card games, such as dice games.

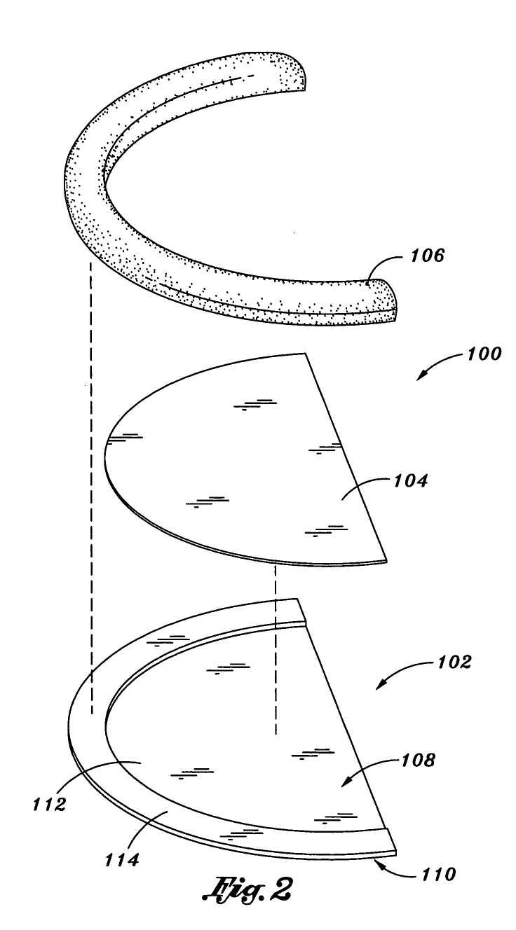

Referring to FIGS. 1 and 2, in a preferred embodiment, the game pad 100 comprises a base 102 (not visible in FIG. 1), a covering 104, a rail 106 and, optionally, one or more additional elements or features.

Referring primarily to FIG. 2, in one embodiment, the base 102 of the game pad 100 comprises a generally planar support. In a preferred embodiment, the base 102 comprises a solid sheet of plastic. In one embodiment, the base 102 has a top or first side 108 and a bottom or second side 110. The base 102 also preferably has a central section 112 and an outer edge or periphery 114.

In a preferred configuration, one portion or end of the base 102 is straight, while an opposing portion or end of the base 102 is curved, and is most preferably generally “U”-shaped. This portion of the game pad 100 preferably terminates at the generally straight end portion or section. So configured, the base 102, and thus the game pad 100, may have a generally half-oval or semi-circular shape. Of course, the base 102, and thus the game pad 100, may have other shapes.

In a preferred embodiment, at least the “U”-shaped portion of the periphery 110 of the base 102 is configured as a raised frame for accepting, as disclosed below, the rail 106. As illustrated, this raised frame may simply comprise an area of increased thickness of the base 102.

In a preferred embodiment the base 104 is constructed of molded plastic. The plastic used for the base 104 may include any durable thermoplastic alloy that provides UL, FAR, MVSS and/or BS fire ratings and exhibits the mechanical properties required to produce the base 102 in a pre-shaped form. An example of an acceptable plastic that can be used for the base 102 includes KYDEX® sheet products.

In one method of constructing the base 102, a plastic form is first designed on a C&C machine to the exact base shape, including the central section and the raised perimeter. A template is then cut out of cardboard to validate the design. Once validated, a base form template is cut out of hard wood.

The completed hard wood template is attached to an oven vacuum form frame. Raw plastic is associated with the form and the plastic material and form are placed in an oven and heated in the vacuumed form (such as to at least 300 degrees). Once heated, the plastic is removed from the oven and placed over the template. A vacuum process is then used to mold the plastic to the shape of the template and into the desired shape. After a cooling process, any excess plastic is trimmed.

In one embodiment, an oval or circular member is formed in the molding process. This member is then cut into 2 pieces, each of which would be used as a base 102 for two different game pads 100.

In another method of constructing the base 102, the base is injection molded in its final form as a one piece element. In this configuration, a mold is constructed and the plastic material is injected into the mold. The molded base is cooled, removed and an excess plastic is trimmed.

The result of such a method is the formation of a generally solid or rigid base 102 having the desired shape, and being relatively light-weight. The base 104 may be constructed from other materials and in other fashions and still have various of the features described herein, although such may result in the game pad 100 being undesirably heavy or not as rigid as desired.

In one embodiment, at least the top side 108 of the base 102 is covered with a covering. In a preferred embodiment, a cover 104, such as in the form of a padded felt insert, is shaped to cover at least the central section 112 of the base 102. Other types of coverings may be utilized. Felt and similar coverings are desirable in that they are relatively high friction and prevent cards from sliding about the game pad too easily. The covering or insert 104 may bear graphics, text, designs or the like, as desired. For example, the covering or insert 104 could bear text referencing card spots, betting areas or the like.

Preferably, the covering or insert 104 is configured to be removable from the base 102. For example, the covering or insert 104 may be attached to the base 102 using hook and loop fastening material, snaps or other means which preferably the covering or insert 104 to be connected to the base 102, but which also permits detachment thereof from the base 102. In that event, one insert or covering 104 may be removed and/or detached and replaced with another insert or covering 104. For example, the user of the game pad 100 may have a number of coverings or inserts 104 are replace them to change the appearance of the game pad 100 (such as for particular events, holidays, particular games to be played or the like).

In a preferred embodiment, a rail 106 is located at the periphery or edge 114 of the base 102, at the raised peripheral area 114 thereof. As described above, preferably only the curved portion of the peripheral area 114 is raised, and the rail 106 is thus preferably only located at that portion of the peripheral area of the game pad 100.

In one embodiment, the rail 106 is raised and padded. The rail 106 may comprise, for example, a support element which is padded (such as with foam or the like) and covered with vinyl or other durable and pleasing material such as leather, cloth or the like. The rail 106 may be constructed of a wide variety of materials, however, and include a variety of ornamental designs and/or be of a variety of colors and textures. In another embodiment, the rail 106 simply comprises a pad material which is covered, and which is connected to the base 102, whereby the base 102 provides the support for the rail 106.

The rail 106 may be attached to the raised frame area 114 of the base 102 in a variety of manners, such as with staples, rivets, snaps, hook and loop fastening material, or other means. In an embodiment where the rail 106 includes a support, the rail 106 may be attached to the base 102 during manufacture thereof with one or more staples (such staples may be passed through a bottom 110 of the base 102 into engagement with the rail 106 located at the opposing top side of the base 102).

In an embodiment where the rail 106 does not include its own support, foam padding, such as constructed from polyurethane (also known as polyfoam) may be located over the frame area 114 of the base 102. Other types of padding may be used, however, such as a plurality of foam rubber materials, fiber, and rubber. The covering is located over the padding. The padding may be secured to the base 102 with glue or other adhesive material or members.

In a preferred configuration, the bottom of the game pad 100 is generally planar. A high friction cover may be applied to the bottom of the base 102, so that when the game pad 100 is placed on a support surface such as a desk, the game pad 100 does not slide too easily about the support surface. In this manner, when a user places their hands on the rail 106 or otherwise uses the game pad 100, it does not readily slide out of position.

The game pad 100 may include a variety of other or additional features or elements. For example, the game pad 100 may include cup and/or food holders of various shapes and designs. Such features may be associated with the game pad 100 in various ways. For example, cup or food holders might be attached to the bottom of the base 102 or the periphery of the base using snaps, rivets, staples, or other means. In one embodiment, the base 102 might include outwardly extending portions, such as a flat portion having an opening therein for defining a cup holder.

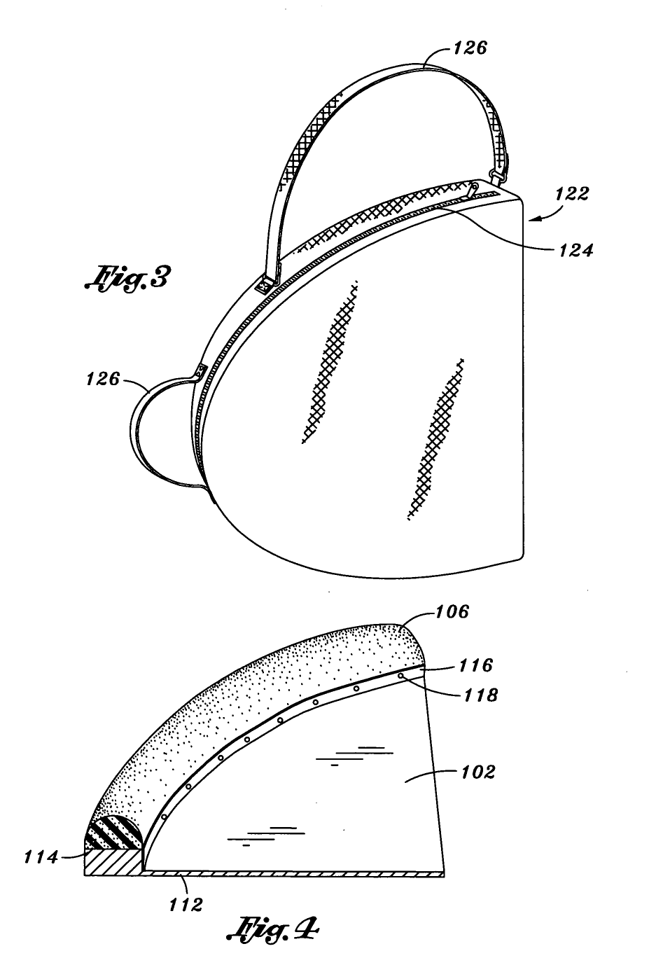

The game pad 100 may include one or more lights or illumination devices. One embodiment of such a configuration of the game pad 100 is illustrated in FIG. 4. As illustrated therein, one or more light/illumination elements or lighting devices 118 may be located at an inwardly extending face 116 at the interface of the central section 112 and the raised outer frame area 114 of the base 102. The lighting devices 118 may be of a variety of types, such as rope lighting, spaced LEDs or other elements. The lighting device(s) 108 may be associated with the game pad 100 in various manners, such as with staples, glue, hook and loop fastening material or the like. In one embodiment, as illustrated, the lighting devices 118 may actually be mounted at least partially within the base 102. As illustrated in FIG. 4, such lighting devices 118 may be configured to shine outwardly onto the central section or “playing surface” of the game pad 100.

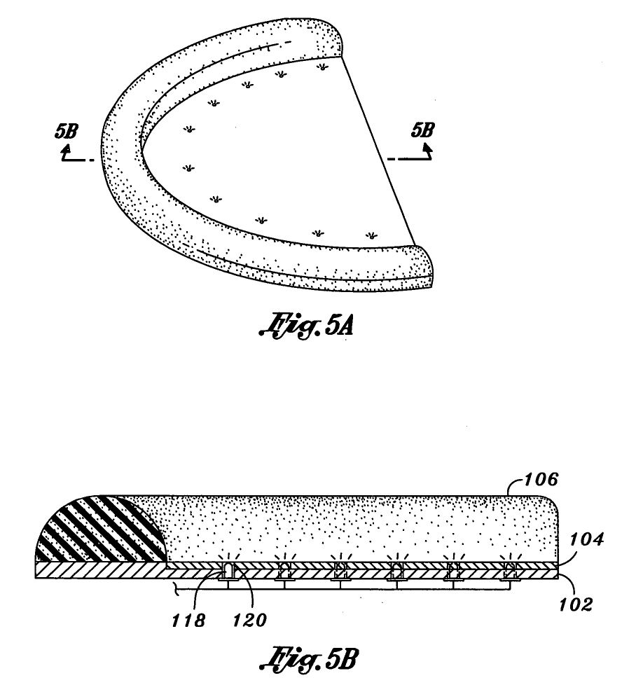

The lighting devices 118 may be associated with the game pad 100 in a variety of locations (such as continuously about the game pad or in spaced locations). For example, another embodiment of an illuminated game pad 100 is illustrated in FIGS. 5A and 5B. As illustrated in FIG. 5B, one or more small holes 120 may be formed in the base 102 for accepting lighting devices 118 and for passage of wiring or power supply elements used to power the lighting device(s) 118 or other optional devices.

In one embodiment, the lighting devices 118 may be located below a portion of the cover 104, to thereby “back light” portions of the cover 104, as illustrated in FIG. 5A. In other embodiments, the lighting devices 118 may extend at least partially through the cover 104, and thus be directly visible.

In other embodiments, the lighting devices 118 may be located at the bottom 110 of the base 102. In such embodiments, the lighting devices 118 may emit light upwardly through substantially transparent/translucent portions of the base 102 or apertures therein. In this configuration, light travels through the base 102 to the cover 104, thereby illuminating portions of the cover 104.

Referring to FIG. 3, the game pad may be transported or stored in a carrying case 122. The game pad may then be positioned inside of the case 122. The carrying case 122 may comprise two sheets of fabric or other material which may be connected along a peripheral edge at one or more locations by one or more zippers 124, snaps or the like. The zippers 124 or other fasteners may be used to open the carrying case 122 and to close the carrying case. The case 122 may also include one or more handles 126 to permit its easy transport. The game pad may be stored in the case 122, such as under a bed or in a storage closet. The carrying case 122 may also be used to store extra inserts/coverings.

Referring to FIG. 1, the game pad 100 is configured to be supported on a support surface. As indicated, the generally planar configuration of the bottom of the game pad 100 is particularly suited to such an application.

As indicated, the game pad 100 has particular applicability to on-line gaming play, such as via a computer. In that application, game pad 100 is preferably located on the top surface S of a desk or similar support surface (computer stand or the like). As configured for such use, the game pad 100 is preferably sized for location on the desk and for use by a single player. Thus, the game pad 100 may only be 12-24 inches wide (side to side) and about 12-20 inches deep (open end to closed end) (though the game pad 100 could have other dimensions, larger or smaller).

In such an application, the game pad 100 is preferably oriented so that the straight end thereof faces away from the player. So oriented, the rail 106 is located closest to the player or user. As configured, the game pad 100 has numerous benefits. First, the game pad 100 can be located directly adjacent a display D of a computer which is used to display game or other information. Because the straight end of the game pad 100 is “open” (it is not raised and does not include a rail 106), it can be located close to the display and does not interfere with viewing of the display D. At the same time, the rail 106 is located adjacent to the player, in similar fashion to stand-alone multi-player gaming tables found in casinos.

As used on a desk or the like, the game pad acts as a desk pad, both for gaming and non-gaming uses. Of course, a player may locate poker chips C or the like on the game pad 100 in order to enhance the player's gaming experience while playing computer or “on-line” type gaming. In addition, however, the game pad 100 may be used as a desk surface where a computer mouse M may be located and other activities may be performed.

In one embodiment, the game pad could be used as part of a game simulation. For example, a gaming company or casino may wish to introduce a new game to prospective buyers or players. To do this in a manner avoiding the need to present the game in live, physical form, the game may be presented via a computer simulation (either interactive or static). In order to make the presentation more “realistic” in relation to how the game would appear if it were presented in live form at a full-size multi-player table, the game pad may be positioned adjacent the display of the computer simulator. In this manner, the party to whom the game is being presented has the “feel” of the table as the game is displayed before them, more accurately simulating how the game would appear in live form. Chips or the like may even be exchanged on the game pad as part of the simulation, further heightening the realism of play. Further, the covering on the game pad might be customized to match the game being simulated (such as by including particular betting locations or the like). In this manner, the game pad may have other unique and beneficial uses.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A game pad comprising:
a generally rigid base having a top and an opposing bottom, a first generally straight end and a second curved end, a raised frame extending upwardly from said top along said curved end, and a central play area between said straight end and said raised frame at said top;
a cover located over at least said central play area; and
a raised rail connected to said base and extending upwardly from said raised frame of said base.

2. The game pad in accordance with claim 1 wherein said base is constructed as a single element of molded plastic.

3. The game pad in accordance with claim 1 wherein said raised rail comprises padding covered by a covering material.

4. The game pad in accordance with claim 1 including at least one light.

5. The game pad in accordance with claim 4 wherein said at least one light is located in said base and illuminates light upwardly through said cover.

6. The game pad in accordance with claim 4 wherein said at least one light is located in a face of said base at said raised frame and illuminates light outwardly towards said cover.

7. The game pad in accordance with claim 4 including a plurality of apertures extending upwardly from said bottom of said base and at least one light in each aperture.

8. The game pad in accordance with claim 4 including means for detachably connecting said cover to said base.

9. The game paid in accordance with claim 1 wherein said bottom of said game pad is generally planar.
